(19) United States
(12) Patent Application Publication
(10) Pub. No.: US 2014/0019305 A1
(43) Pub. Date: Jan. 16, 2014

(54) Cloud-driven Social-network Platform focused on Pattern Analysis

(71) Applicants: Mukesh Shetty, Iselin, NJ (US); Yogesh Shetty, Iselin, NJ (US)

(72) Inventors: Mukesh Shetty, Iselin, NJ (US); Yogesh Shetty, Iselin, NJ (US)

(21) Appl. No.: 13/548,689

(22) Filed: Jul. 13, 2012

Related U.S. Application Data
(60) Provisional application No. 61/670,720, filed on Jul. 12, 2012.

(51) Int. Cl. G06Q 30/06; G06Q 40/06

(52) U.S. Cl. 705/27.1

(57) ABSTRACT

A cloud-driven social-network platform focused on data pattern analysis that includes strategy modules operable on a digital processor. These analyze data-sets related to a product of interest and predict future values. The platform allows a user to select a strategy module, download and run it. Data-sets and canvas-modules can be obtained. Canvas modules display analyzed data. Author-users upload their strategy-modules, data-sets and display canvases and make them available to other users. The platform includes quality ratings obtained by analyst testing and user feedback that are a factor in pricing the modules. A Cloud Oriented Analysis Language (COAL) is used and compiling is performed by socially aware compilers that compare the code with known strategy modules and suggests changes. The analysis-functions are executed by a socially-aware runtime engine. The strategy-modules may price underlying exchangeables to provide tradable derivative contracts. The platform automatically establishes links between news events and strategy modules.

### CLAIM OF PRIORITY

This application claims priority U.S. provisional patent application 61/670,720 entitled “A Cloud-driven Social Network Platform focused on Pattern Analysis” filed on Jul. 12, 2012, the contents of which are hereby included by reference in their entirety.

### FIELD OF THE INVENTION

The invention relates to methods and systems for setting up a cloud-driven social-network platform focused on pattern analysis, and more particularly, a social network platform that may be used to buy, sell, test and create strategy modules and the associated sets of data and graphic display canvases, including using social software for checking and refining modules.

### BACKGROUND OF THE INVENTION

In capital markets, i.e., markets in which stocks and bonds are bought and sold, traders have, since the advent of commercial computers in the early 1960 s, used mathematically based, computer implemented software models to attempt to create automated trading strategies that inform them of what stocks to buy or sell and when it is best to buy or sell that particular stock or bond.

A trading strategy typically attempts to detect a correlation between prices and events, or prices and prior price patterns. An automated trading strategy may be defined in the form of logic expressions and may include mathematical transformations, all packaged into computer executable software. Not all correlations in an automated trading strategy need be rational, or even driven by economic analysis. The buying and selling patterns of many traders may be influenced to a greater or lesser degree by superstitions such as astrology, numbers or lucky events. The weather, results of major sporting events and political events are other factors known to have a significant influence on trading patterns. The result is that possible trading strategies are limited only by a trader's imagination and their ability to translate those ideas into workable software. The present invention may not help a trader's imagination, but will provide them with an environment in which to translate their ideas for an automated trading strategy into a reality in the form of a working software implementation of their proposed strategy, without the need to buy expensive hardware, hire costly programmers or learn arcane computer languages.

In the market place of this invention, the infrastructure required may be sourced from cloud in the form of servers provided by, for instance, Amazon.com's Amazon Web Service™ Microsoft's Windows Azure™ cloud services, and “GoGrid™'s “Infrastructure as a service” capability.

In the present invention, the cloud-driven social-network platform market place focused on pattern analysis may be divided into at least three categories: a strategy marketplace, a data market place and a canvas marketplace. Users may be able to access each of the marketplace sectors as either an author or a subscriber. Authors may be the creators who source, build, devise or otherwise obtain data sets, strategies and visual cues for representing data. Subscribers may be the consumers of the items provided by the author community.

The strategy market place may, for instance, be a one stop shop for buying or selling strategies. A strategy may, for instance, use data offered in the in the data market place to build analytics that will allow users of the strategy to make informed and intelligent decision on when to buy or sell a product.

Similarly, the data market place where a wide range of data-sets needed in building, testing and implementing a trading strategy are available. The data market place may also be an opportunity for data providing users to supply premium datasets to other subscribers on whatever terms they decide are mutually agreeable.

A third market element—the canvas marketplace—may offer subscribers a variety of tools that may allow them to display data from the data market place or data resulting from the execution of trading strategies. The canvases may provide graphic or other visual cues and formats that make the data easier to comprehend. In existing capital markets, for instance, stock prices are typically plotted using a line chart. Other types of visual cues that may be available to represent stock prices include bar-charts, pie-charts and 3-D graphics that may combine both price and volume as functions of time. Subscribers may, for instance, choose from a variety of types of visual cue's to provide data display that is efficient, effective and which may improve decision making.

Although the invention has been described in terms of a capital marketplace, the same tools may be provided for a variety of marketplaces such as, but not limited to, bioinformatics, consumer products, commodities, sporting outcomes and election outcomes. These will be described in more detail later.

### DESCRIPTION OF THE RELATED ART

The relevant prior art includes:

U.S. Pat. No. 8,122,429 issued to Ramsey et al. on Feb. 21, 2012 entitled “Method, system and program product for developing a data model in a data mining system” that describes a database table of predefined data transformations is provided. Each predefined data transformation is associated in the table with a unique identifier, a corresponding description and a validity period. When a data modeler wishes to develop a data model for a desired prediction, he/she will first determine a set of variables that will be used therefor. The set of variables can include any of the predefined data transformations from the database table. The data model will then be developed by applying raw data to the set of variables and determining a mathematical relationship there between. Once the data model has been developed, the data modeler will write a reusable specification for applying the data model operationally. Thereafter, IT personnel or the like can code and deploy the data model using the specification.

U.S. Pat. No. 8,065,257 issued to Kuecuekyan on Nov. 22, 2011 entitled “System and method for correlating past activities, determining hidden relationships and predicting future activities” that describes a system and method of data correlation and analysis of past activities and prediction of future activity that includes establishing a database comprising structured metadata on at least one computer and a distributed system of networked computers having a plurality of access levels, configuring a database front-end to parse incoming data, the database front-end defining a plurality of entities and events, each having one or more attributes, and correlation IDs, which are user defined attribute relationships that correlate events and entities, collecting data, parsing the incoming data in the database front-end into structured metadata, the distributed analysis engine correlating the incoming structured metadata with structured metadata in the database and determining micro-patterns in the structured metadata, generating a graphical representation of a composite network of the determined micro-patterns as super-objects, and predicting future activity from the one or more super-objects representing the determined micro-patterns.

U.S. Pat. No. 7,496,888 issued to Sanjar et al. on Feb. 24, 2009 entitled “Solution builder wizard” that describes displaying a palette containing icons representing available system components for use in a solution. Associated with the icons are partially defined behavioral models, implementation logic, and user-modifiable parameters and options in a markup language format. Instances of the configurable behavioral models are instantiated through selection by a user. A design area of the display shows icons for the instances, where they are placed and arranged by the user, including connection logic and user-input model interface and behavioral logic parameters. The models are configured according to the parameters by modifying the associated markup language. A system solution behavioral model is automatically created in a modeling language comprising a collection of the interconnected and fully defined component behavioral model instances, allowing simulation of operation of the system solution.

U.S. Pat. No. 7,509,629 issued to Sakamoto et al. on Mar. 24, 2009 entitled “Method for system and architecture design using unified modeling language (UML)” that describes a UML design method by which architecture design pursuing optimal design parameters while viewing the overall target system on the UML model can be performed. A UML design method of the present invention is a UML design method for performing design by modeling a target system based on Unified Modeling Language (UML), using a profile storing a design parameter, the method including the steps of: storing a stereotype and a tagged value in the profile as the design parameters; annotating a UML model of the target system with the stored stereotype and tagged value; and associating the added stereotype and tagged value with each class constituting the UML model, and displaying the stereotype and tagged value and the UML model, which are associated, on a graphical user interface.

Various implements are known in the art, but fail to address all of the problems solved by the invention described herein. One embodiment of this invention is illustrated in the accompanying drawings and will be described in more detail herein below.

### SUMMARY OF THE INVENTION

The present invention is directed to methods and systems for a cloud-driven social-network platform focused on data pattern analysis.

In a preferred embodiment, the platform may include a strategy-module repository that may contain at least one strategy module, operable on a digital processor. The strategy module may, for instance, include instructions for implementing functions on the processor such as, but not limited to performing an analysis of a data set that may be related to the value of a product of interest to a user. The analysis may, for instance, be used to determine a predicted future value of the product.

In a preferred embodiment, the platform may also include strategy market home page that may be accessible by a member of the cloud-driven social-network. The strategy market home page may, for instance, have instructions for functions that allow a user to select a strategy module from the strategy-module repository and to then access it from the repository and execute it on a cloud-based processor. The platform may also have a data-module home page that allows the user to download data sets from a data-module repository, and a canvas-module home page that allows the user to obtain a canvas module to display the analyzed data.

In a preferred embodiment, the platform may also include ways in which an author user may upload their own strategy-modules, data and display canvases to the repositories in the marketplace and to make them available to other users on mutually agreeable terms.

The social-network platform of the present invention may also include quality ratings of the strategy modules, the data sets and the display canvases. This quality rating may, for instance, be obtained by testing on the site, by feedback from the users or some combination thereof. The quality rating may, for instance, be a factor in pricing the various modules.

In a preferred embodiment the social-network platform may also offer a Cloud Oriented Analysis Language (COAL) that may be used for coding analysis-modules as a series of human readable statements. Compiling these statements may also be performed by a socially aware compiler that may, for instance, be able to compare the code with other known functions and/or strategy modules for the purpose of making, or suggesting, code changes to improve or optimize speed, reliability or accuracy or some combination thereof. The socially aware compiler may also be able to traverse the datasets and provide guidance on which datasets may be appropriate to combine with the strategy module, without revealing any proprietary information from those datasets without appropriate permissions or purchase.

The analysis-functions may be executed by a socially aware runtime engine that may similarly compare and improve executable code by comparison with other code modules have a similar or related functionality.

The cloud-driven social-network platform of the present invention may also use the strategy modules to price an underlying exchangeable for the purpose of providing a tradable derivative contract. Such underlying exchangeable that may be suitable for providing derivative contracts include, but are not limited to, mortgages, economic reports, freight costs, an inflation rate, weather conditions, emission measurements or some combination thereof.

In a preferred embodiment, the cloud-driven social-network platform of the present invention may also automatically establish links between news events and product values one or more of the strategy modules in the strategy-module repository. The platform may also automatically display notifications of such link.

The platform may have the capability to construct a model “on the fly”, i.e., in quasi-real time. Such a model may, for instance, be constructed in response to a user search request, such as, but not limited to, a keyword search for “Facebook IPO”. In response, the platform may, for instance, construct a model that may access one or more IPO datasets that may correspond to IPOs of companies having some commonality to Facebook, such as, but not limited to, being in similar market or technologies spaces, having similar products, being of similar gross revenues, or number of employees or years of experience or some combination thereof. Using those datasets, the platform may generate a model encompassing one or more of the generalities and may tune that model by running it on further IPO datasets and may then use it to generate a performance prediction, such as, but not limited to, a graph, for the specific event in question, i.e., the “Facebook IPO”. In this way, the platform may transform a search into a prediction.

Although present invention has been described above primarily with respect to stocks and bonds being the product of interest, the product may be any suitable item or event such as, but not limited to, a retail product, a sporting event outcome, a health bioinformatic or some combination thereof.

Therefore, the present invention succeeds in conferring the following, and others not mentioned, desirable and useful benefits and objectives.

It is an object of the present invention to provide an affordable and simple platform to allow individual users the ability to create and use strategy analysis tools.

It is another object of the present invention to provide a user with all the related tools including sets of data and methods of displaying the data.

Yet another object of the present invention is to provide a market place for the exchange of strategy analysis tools, including strategy modules, data and display canvases.

Still another object of the present invention is to provide a basis for derivative contracts, and a marketplace for the derivative contracts.

Still another object of the present invention is to provide a socially aware platform of software, compilers and runtime engines.

### BRIEF DESCRIPTION OF THE DRAWINGS

FIG. 1 shows a schematic overview of a cloud-driven social-network platform in accordance with the present invention.

FIG. 2 shows a schematic overview of the repositories and home pages in accordance with the present invention.

FIG. 3 shows a schematic flow diagram of some of the steps in using the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

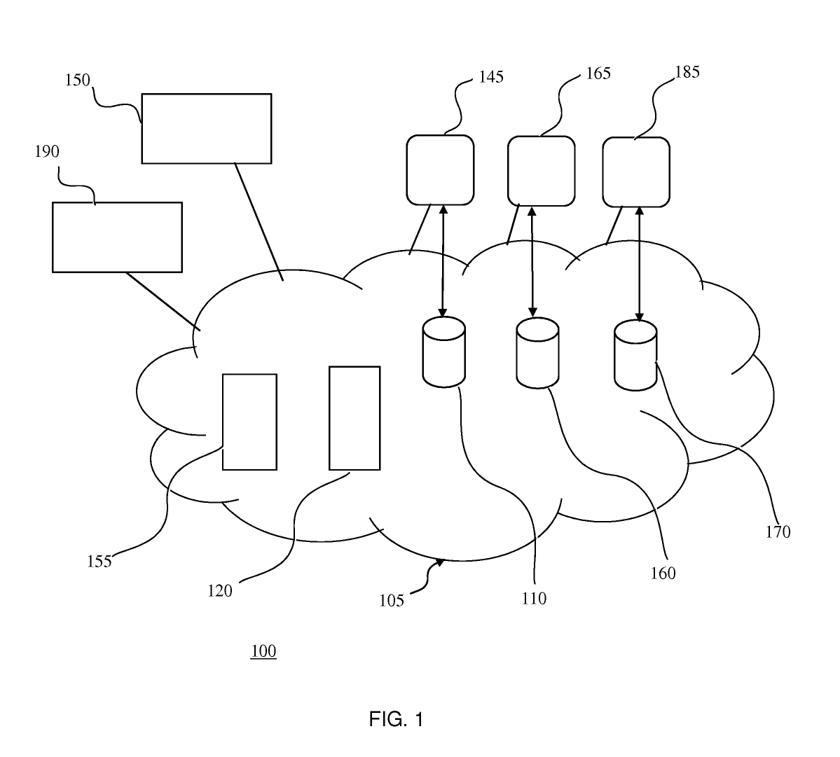

FIG. 1 shows a schematic overview of a cloud-driven social-network platform in accordance with the present invention.

The cloud-driven social-network platform 100 includes a strategy market home page 145 that may be linked both to a communications network cloud 105 as well as to a strategy-module repository 110 that may be located somewhere on the cloud 105, meaning that the physical infrastructure that may constitute the strategy-module repository 110 may physically reside anywhere in the world, but is reachable, typically by high speed Internet connection, so that the hardware and software running on it may appear to be local to, or even within, a user's Internet connected computer or other data processing device.

The cloud-based physical infrastructure may, for instance, be sourced from services such as, but not limited to, Amazon.com's Amazon Web Service™, Microsoft's Windows Azure™ cloud services, and “GoGrid™'s “Infrastructure as a service” system.

Users of the service such as the subscriber-member 150 and the author-member 190 may interface with the cloud-driven social-network platform 100 via the Internet, and in particular, via one of more webpages such as, but not limited to, the strategy market home page 145, the data-module home page 165 and the canvas-module home page 185.

Each these home pages may contain HTML or similar code that allows a user to perform a number of functions.

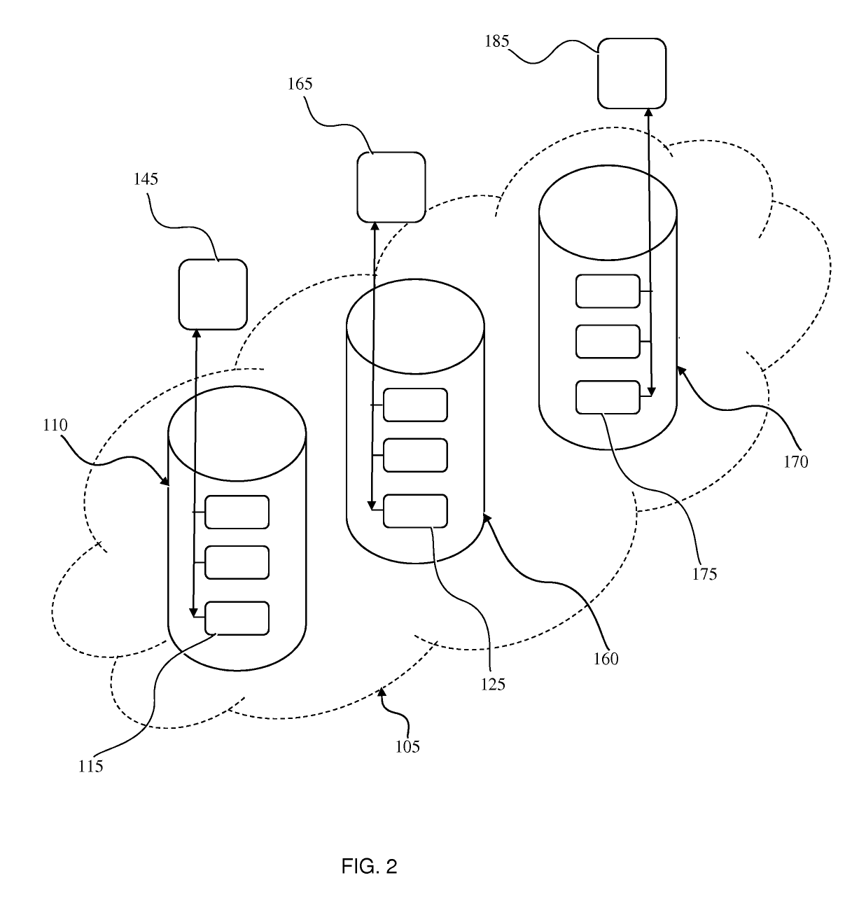

The strategy market home page 145 for instance, allows a subscriber-member 150 to access a strategy-module repository 110 that may, for instance, be located on the cloud 105. The subscriber-member 150 may obtain a strategy module 115 (see FIG. 2) that they may then run on a digital processor 120 that may also be located on the cloud 105. A author-member 190 may, instead, use the strategy market home page 145 to place a strategy module 115 on the strategy-module repository 110 for use by, or sale to, subscriber-members 150.

Similarly, the data-module home page 165 may allow a subscriber-member 150 to access a data-module repository 160 that may, for instance, provide them with data set 125 (see FIG. 2) that they may use when running their strategy module 115. An author-member 190 may, for instance, use the data-module home page 165 to place a data set 125 on the data-module repository 160 for use by, or sale to, subscriber-members 150.

The subscriber-member 150 may also be able to access a canvas-module home page 185 that may, for instance, be set up to allow them to select a canvas module 175 (see FIG. 2) that they may use to display results obtained from running their strategy module 115. An author-member 190 may, for instance, use the canvas-module home page 185 to place a canvas-module home page 185 of their devising on the canvas-module repository 170 for use by, or sale to, subscriber-members 150.

The subscriber-member 150 and the author-member 190 may have access to a cloud-based processor 155 as well as to a digital processor 120 that may or may not be located on the cloud 105.

FIG. 2 shows a schematic overview of the repositories and home pages in accordance with the present invention. FIG. 2 shows, schematically, the cloud 105 located strategy-modules 115, data-module repository 160 and canvas-module repository 170 and their associated web home pages, i.e., the strategy market home page 145, the data-module home page 165 and the canvas-module home page 185.

Each repository may contain an appropriate software module. The strategy-module repository 110 may, for instance, contain one or more strategy modules 115. A strategy module 115 may, for instance, be a software module that may operable on a digital processor 120. The strategy module 115 may, for instance, have computable readable instructions that enable the digital processor 120 to perform functions such as, but not limited to, analyze a data set 125 related to a value of a product to determine a predicted future value of the product.

A subscriber-member 150 may, for instance, access the strategy market home page 145 of the cloud-driven social-network platform 100 in order to select a strategy module 115 from the strategy-module repository 110. The subscriber-member 150 may then download the strategy module 115 to their home computer or a cloud-based processor 155 that they are able to access. In a preferred embodiment, the strategy module 115 may execute on a cloud environment where the entire backend engine may be constructed to execute the strategy efficiently.

They may also, or instead, access a related webpage that may be associated with the same website such as, but not limited to, a data-module home page 165. The data-module home page 165 may, for instance, allow the user to access a data-module repository 160 that may have one data sets 125 having information related to the value of the user's product of interest.

From the data-module home page 165, the subscriber-member 150 may, for instance, be selecting a data set 125 from the data-module repository 160. The subscriber-member 150 may, for instance, then download the selected data set 125 to a cloud-based processor 155 and may, for instance, use the data set in running their strategy module 115.

The subscriber-member 150 may also, or instead, access a related webpage that may be associated with the same website such as, but not limited to, a canvas-module home page 185. The canvas-module home page 185 may, for instance, allow a subscriber-member 150 to access a canvas-module repository 170 that may contain one or more canvas modules 175. Each canvas module 175 may, for instance, have computer code or instructions that enable the display of a data set, or the results of running a strategy module 115 using a particular data set 125.

From the canvas-module home page 185, the subscriber-member 150 may select a canvas module 175 from canvas-module repository 170 and download it to a cloud-based processor 155 that they may have access to.

The cloud-driven social-network platform may also be structured so that author-members 190 may place software modules they have acquired, or written, on the appropriate repositories so they can be accessed and used by other members of the marketplace. The home-pages may be structured so that an author-member 190 may make their software modules available in return for a valuable consideration 215 that may be mutually agreeable to them and the subscriber-member 150 wanting to use the module. This may, for instance, be accomplished via a third party electronic payment site such as, but not limited to, PayPal™.

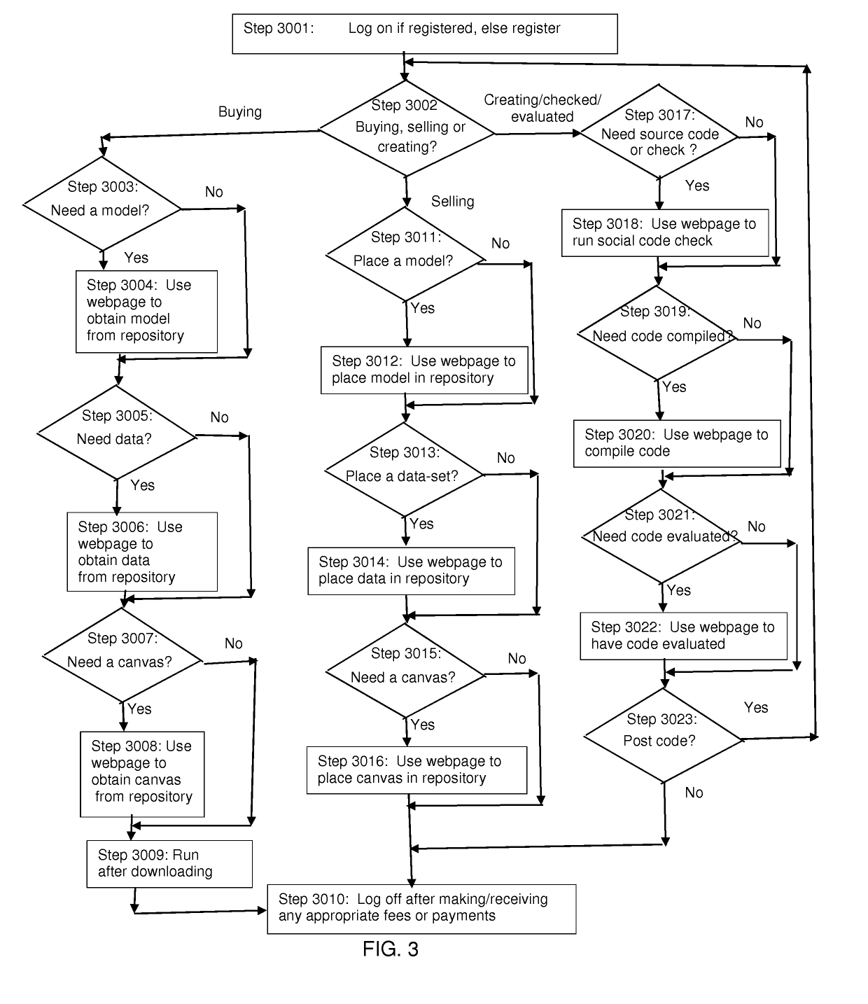

FIG. 3 shows a schematic flow diagram of some of the steps in using the present invention.

Step 3001: Log on if registered, else register. In this step a user may register to become a member of the cloud-driven social-network platform 100. Membership may be free, by subscription, or per use or some combination thereof. There may also be various tiers of membership such as, but not limited to, subscriber-membership and author membership, and there may be sub-tiers within those categories that provide access to different repositories, or sections of repositories. In a preferred embodiment, membership may be free and may include the use of various quantities of various types of service, but charges may be levied for further types of services and for various quantities of service. A newly registered user may, for instance, be entitled to a certain amount of computer time and a certain amount of computer memory. Use of further computer time and more computer memory may incur a charge, as may use of other computer services such as, but not limited to, certain elements for construction of certain types of model.

Step 3002: Buying, selling or creating? At this step, a user may have the option to purse one of three paths.

They may, for instance, select a “buying” option, in which the user may select software modules that are fully developed and that may be run immediately.

In this mode the user may proceed to Step 3003: Need a model? If a model is required, the user may proceed to Step 3004: “Use webpage to obtain model from repository” to select and download one of the strategy modules 115 that are currently available on the strategy-module repository 110.

The cloud-driven social-network platform 100 may then direct the user to Step 3005: “Need data?”. If the user requires a data-set to test or run a model, they may proceed to Step 3006: “Use webpage to obtain data from repository”, in which they may select and download an appropriate data set 125 from the data-module repository 160.

The cloud-driven social-network platform 100 may then direct the user to Step 3007: “Need a canvas?” If the user requires a canvas module to display the data generated by their strategy module 115 running a particular data set 125, they may proceed to Step 3008: “Use webpage to obtain canvas from repository”, in which they may select and download an appropriate canvas module 175 from the canvas-module repository 170.

In Step 3009: “Run after downloading” a user may select to run the software modules they have acquired. This may be done on their computers, a cloud based server accessed via the social-network platform 100, on a 3^{rd} party computer or some combination thereof. In a preferred embodiment, running or executing the software modules may always occur on the cloud infrastructure.

Back at step 3002, a user may have elected the “Selling” option. This option may be set up for author-members 190 who may wish to share software they have developed, or data they have gathered with other users. They may want to make these items freely available to the community or to sell them at a prearranged price or even to negotiate mutually agreeable terms with individual users or some combination thereof. In a preferred embodiment, the platform may provide a robust billing platform where an author-member 190 may configure how they may want to sell a dataset, a model, or a canvas or a combination thereof. The seller or author-member 190 may, for instance, offer a free or low cost trial subscription so that a user may familiarize themselves with the data, model or canvas before buying a full subscription.

Step 3011: Place a model? If the author-member 190 has a strategy module 115 that they have developed or acquired from a 3^{rd} party vendor, they may proceed to Step 3012: Use webpage to place model in repository. In this step they may be guided as to how to deliver a strategy module 115 to the strategy-module repository 110, and how to charge for the model if they want to. The charging may be via a fixed price and use a 3^{rd} Party electronic payment option such as, but not limited to, the PayPal™ website, or it may involve an IM or email negotiation between the author-member 190 and a subscriber-member 150. The charge may be on a per use basis, and may be adjusted for the size of the user, the size of the database, the type of data being run or the method of collecting and/or displaying the results of the processing, or some combination thereof.

In a similar fashion, Step 3013 “Place a date-set?” and Step 3015: “Need a canvas” may lead on to Step 3014 or Step 3016 in which the respective web home-pages may enable or assist an author-member 190 to place their data set 125 or canvas module 175 on the respective repositories.

At Step 3002, a user may have selected a third option, electing to be created, checked or evaluated.

This may lead them to Step 3017 “Need source code or check?” What may be offered via this step is an opportunity for a user to obtain source code fragments or subroutines that may be used in putting together a software module. These routines may be available at the level of, for instance, a function that may perform a particular mathematical or logical operation given some predefined parameters and input data. The functions or routines may themselves be part of a strategy module available in the strategy market place and a user may therefore use other people's functions and routines that are on offer in the marketplace and which may be free or may cost.

The code check available in Step 3018 may include a check by a socially aware code checker. The source code being checked may be in some predetermined computer language, but preferably one that is sufficiently close to natural language to be readable by someone who is not a programming expert. Cloud Oriented Analysis statements (COAL) are one such language, and more detail concerning them is provided in Appendix I.

A socially aware source level code checker may have access to other routines written in the same source code and that may perform a similar function but were written by other programmers. By comparing the user's source code with other source code, areas of the code may be identified, and brought to the user's attention, such as, but not limited to, areas where there is a high level of similarity, but in which parts are very different. These regions may, for instance, highlight code that is attempting to perform different functions, but which may have different approaches to coding the problem. Such regions may indicate coding errors or alternate and perhaps better ways of formulating or coding the problem.

In Step 3019: “Need code compiled?” a user has the option to have their source code compiled. In a preferred embodiment, this compiling may be done in Step 3020 by a socially aware compiler, i.e., a compiler that may have access to compiled versions of code written by other people. By comparing the compiled code to other compiled code that may be designed to solve similar problems. Comparison of the compiled versions may indicate areas that may be made faster or more efficient. For instance, the comparison may find regions that have marked similarities, but also some differences. Examining the differences may be a fruitful way of identifying both mistakes and regions that may be further optimized.

The compiled code may even be run on a socially-aware execution runtime engine 240.

Step 3021: “Need code evaluated?” A user may select to go to Step 3022: “Use webpage to have code evaluated”. The evaluation may, for instance, be having the user's strategy module 115 evaluated using an historical data-set 125. For instance, the evaluation may take a first part of the historical data set as the input and use the strategy module 115 to make a prediction about a second part of the historical data set. The degree of accuracy of such a predication may indicate how well the strategy module 115 works, and may be used to classify the model.

Having strategy modules 115 evaluated and scored according to some defined methodology may be a way to value how good they are. The evaluation, or the strategy module quality rating 210 obtained by the evaluation, therefore, may be a factor in the price asked for the strategy module 115. The valuable consideration 215 may, for instance, be assessed, in part, on the strategy module quality rating 210.

Similarly both data sets 125 and canvas modules 175 may be evaluated by similar methods, or by related methods such as, but not limited to, user feedback, an expert panel, efficiency or some combination thereof.

The valuable consideration 215 asked for these modules may also be assessed, in part, on the data-set quality-rating 220 or the canvas-module quality-rating 225.

In a further preferred embodiment of the invention, the strategy module 115 may be used to provide a means of pricing an asset for the purpose of producing a tradable derivative.

Commodities futures are a common form of derivative contract. In a commodities future, a buyer commits to paying now for a commodity to be delivered at a future date, while a seller takes the money now, and agrees to deliver the commodity at that future date. For instance, a farmer may enter into a derivatives contract to supply a given quantity of grain in six months' time at a specific price. A speculator may agree and give the farmer the money for the future grain. The farmer may then use the money to pay for the seed and nurturing of the grain to maturity. At the specified time, the farmer then delivers the grain they are contracted to deliver. An important aspect of derivative contracts is a model for predicting the future values of the underlying exchangeable, in this case the grain. With a commodity like grain, there are historical records that help predict what the future price will be. In the example above, the farmer, in addition to obtaining liquidity at the time they most need it, is essentially betting that this year's harvest will be better than average, and that when it is time to deliver, they will have an excess of grain and that prices will be below average. The speculator, in addition to effectively building a reasonable interest rate into the calculated price, is effectively betting that this year's harvest will be worse than usual, and that with a shortage of grain, the prices will be higher than average.

As noted above, almost anything can be used as the underlying exchangeable in a derivatives contract—as long as there is an agreed upon method of valuing the exchangeable. There are, for instance, weather futures that are traded by energy producers and are priced according the number of days of temperatures above or below the average temperature for that day, and factor in the amount above or below average. As energy companies can quantify the additional cost of energy dependent on the temperature, and the average temperature can be predicted from historical data, an agreed value can be assigned, and weather futures can be traded as derivatives contracts.

In a further preferred embodiment of the present invention, strategy modules 115 produced using the cloud-driven social-network platform 100 may form the basis of tradable derivative contracts 250 in a variety of exchangeable items such as, but not limited to, mortgages, economic reports, land sea and air freight costs, country specific inflation rates or baskets thereof, weather conditions, emissions measurements or some combination thereof.

The cloud-driven social-network platform 100 may further provide a prediction exchange market that may be similar to a stock market. In such a prediction exchange market, computer driven prediction or strategy modules such as those that may be built on the cloud-driven social-network platform 100, may provide the instruments listed for trading. Traders, i.e., buyers and sellers of the listed instruments, may, for instance, effectively bet on the future outcome of the listed prediction model. The original author of the model on which trading, or betting, is allowed may receive a commission based on the trades.

In a further preferred embodiment of the present invention, the cloud-driven social-network platform 100 may be used to automatically establish links 255 between a news event 255 and a value 130 of a product 135 of a strategy module 115 located in the strategy-module repository 110. These links may then be displayed. Such news links may, for instance, be news concerning an event such as, but not limited to, a retail product 260, a sporting event outcome 265 or a health bioinformatic 270, and the linked model may, for instance, be link that news to the price of a stock or a sector of the stock market.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A cloud-driven social-network platform focused on data pattern analysis, comprising:
A strategy-module repository, said strategy-module repository comprising at least one strategy module operable on a digital processor, said strategy module having instructions for functions comprising:
analyzing a data set related to a value of a product to determine a predicted future value of said product; and,
a strategy market home page, accessible by a first member of said cloud-driven social-network platform, said strategy market home page having instructions for functions comprising:
selecting, by said first subscriber-member, at least one strategy module from said strategy-module repository; and
executing said strategy module on a cloud-based processor accessible by said subscriber-member.

2: The cloud-driven social-network platform of claim 1, further comprising:
A data-module repository comprising at least one data set related to said value of said product; and,
a data-module home page, accessible by said subscriber-member of said cloud-driven social-network platform, said strategy market home page having instructions for functions comprising:
selecting, by said subscriber-member, at least one data set from said data-module repository; and
downloading said data set to a cloud-based processor accessible by said subscriber-member.

3: The cloud-driven social-network platform of claim 2, further comprising:
a canvas-module repository comprising at least one canvas module, said canvas module having instructions for functions comprising:
displaying a data set using at least one graphic cue; and,
a canvas-module home page, accessible by said subscriber-member of said cloud-driven social-network platform, said having instructions for functions comprising:
selecting, by said subscriber-member, at least one canvas module from said canvas-module repository; and
executing said canvas module on a cloud-based processor accessible by said subscriber-member.

4: The cloud-driven social-network platform of claim 1, wherein said strategy market home page further comprises instructions for functions comprising:
downloading, by an author-member of said cloud-driven social-network platform, one of said strategy modules to said strategy-module repository.

5: The cloud-driven social-network platform of claim 4, wherein said strategy market home page further comprises instructions for functions comprising:
transferring a valuable consideration from said subscriber-member to said author-member when said subscriber-member selects said strategy module downloaded by said author-member.

6: The cloud-driven social-network platform of claim 1, wherein said data-module home page 165 further comprises instructions for functions comprising:
downloading, by an author-member of said cloud-driven social-network platform, one of said data seta to said data-module repository; and
transferring a valuable consideration from said subscriber-member to said author-member when said subscriber-member selects said data set downloaded by said author-member.

7: The cloud-driven social-network platform of claim 1, wherein said canvas-module home page further comprises instructions for functions comprising:
downloading, by an author-member of said cloud-driven social-network platform, one of said canvas modules to said canvas-module repository; and
transferring a valuable consideration from said subscriber-member to said author-member when said subscriber-member selects said canvas module downloaded by said author-member.

8: The cloud-driven social-network platform of claim 5, wherein said strategy module is further associated with a strategy module quality rating; and wherein said valuable consideration is assessed, in part, on said strategy module quality rating.

9: The cloud-driven social-network platform of claim 6, wherein said data set is further associated with a data-set quality-rating; and wherein said valuable consideration is assessed, in part, on said data-set quality-rating.

10: The cloud-driven social-network platform of claim 7, wherein said canvas module is further associated with a canvas-module quality-rating; and wherein said valuable consideration is assessed, in part, on said canvas-module quality-rating.

11: The cloud-driven social-network platform of claim 1, wherein said instructions for functions comprise at least one Cloud Oriented Analysis Language statement.

12: The cloud-driven social-network platform of claim 11, wherein said Cloud Oriented Analysis statements are compiled by a socially aware compiler.

13: The cloud-driven social-network platform of claim 12, wherein said compiled Cloud Oriented Analysis statements are executed by a social execution runtime engine.

14: The cloud-driven social-network platform of claim 1, further comprising using said strategy module to price an underlying exchangeable for the purpose of providing a tradable derivative contract.

15: The cloud-driven social-network platform of claim 14, wherein said underlying exchangeable is one of a mortgage, an economic report, a freight cost, an inflation rate, a weather condition, or an emissions measurement.

16: The cloud-driven social-network platform of claim 1 wherein said strategy market home page further comprises instructions for functions comprising:
automatically establishing a link between a news event and said value of said product of at least one strategy module from said strategy-module repository; and
automatically displaying a notice of said link.

17: The cloud-driven social-network platform of claim 16, wherein said product is one of a retail product, a sporting event outcome and a health bioinformatic.

18: The cloud-driven social-network platform of claim 1 wherein said strategy market home page further comprises instructions for functions comprising:
automatically parsing a search term;
providing, in quasi real-time, an appropriate data-set, strategy module and canvas; and
generating a prediction, using said appropriate data-set, strategy module and canvas, related to said search term.
